(19) United States
(12) Patent Application Publication
(10) Pub. No.: US 2024/0004178 A1
(43) Pub. Date: Jan. 4, 2024

(54) ILLUMINATION DEVICE AND MICROSCOPY METHOD FOR GENERATING A COMPOSITE IMAGE OF A SAMPLE

(71) Applicant: Carl Zeiss Microscopy GmbH, Jena (DE)

(72) Inventor: Jana Lepschi, Jena (DE)

(21) Appl. No.: 18/339,316

(22) Filed: Jun. 22, 2023

(30) Foreign Application Priority Data
Jun. 29, 2022 (DE) 10 2022 206 605.7

(51) Int. Cl. G02B 21/06

(52) U.S. Cl. CPC G02B 21/06

(57) ABSTRACT

An illumination device for a microscope and a method for generating a composite image of a sample using the illumination device. The illumination device has at least two providing beam paths, along each of which radiation is guided, each providing beam path having an optical filter device, by means of which spectral components of the radiation guided in the respective providing beam path are selected. Each of the optical filter devices is individually controllable and has a plurality of selectable possible filter functions. Per providing beam path there is an input coupling element for the input coupling of the filtered radiation via a respective incidence opening into an interior space of a cavity provided with a coating that is reflective for the filtered radiation, in particular into an Ulbricht sphere. In this case, the cavity has an exit opening used to emit the radiation that has been homogenized in the cavity owing to multiple reflection as illumination radiation.

### REFERENCE TO PRIORITY APPLICATION

The present application is a U.S. National Stage application of German Application No. 10 2022 206 605.7 filed on Jun. 29, 2022, the contents of which are herein incorporated by reference in their entirety.

### FIELD OF THE INVENTION

The invention relates to an illumination device and also a method for generating a composite image of a sample in the field of microscopy.

### BACKGROUND OF THE INVENTION

In order to be able to create image recordings of samples, in particular of sensitive objects, with a high quality and with as little adverse effect on the relevant samples as possible, these image recordings are intended to be effected with illumination which has a (sufficiently) high intensity in conjunction with a uniform intensity profile.

In order to satisfy these requirements, a high-intensity light source having a good beam quality can be used. However, these sources are cost-intensive and require an increased outlay for adjustment.

In a different solution, the radiations from a plurality of light sources of the same wavelength can be combined. Owing to the same wavelength, a beam splitter is not suitable for combination since in the case of a 50/50 beam splitter, for example, high radiation losses occur owing to reflection.

It is also possible for the radiation from a plurality of light sources to be coupled into a common light guide. However, considerable losses resulting from the light guide and owing to the input coupling should be expected in this case.

The prior art discloses an optical component having an interior space, i.e. a hollow space. Wall and interior space may hereinafter also be referred to jointly as cavity. This component, also referred to as an Ulbricht sphere, has an exit opening and at least one incidence opening. Radiation is directed into the interior space through the incidence opening, and is multiply reflected back (diffusely) in different directions owing to a reflective coating of the inner wall. The reflected rays arrive at the exit opening from different angles and directions, and so the illumination radiation emitted there to outside the cavity has a homogeneous intensity profile.

This principle is applied for example in a device in accordance with DE 101 060 32 A1 in order to use the homogeneous illumination radiation to excite fluorescent radiation in a sample and optionally to detect it by way of reflected light and/or by way of transmitted light.

WO2021/197207 A1 discloses a broadband light source comprising an Ulbricht sphere. The light source in that case makes available homogeneous illumination radiation of predetermined wavelengths.

### OBJECTS OF THE INVENTION

The invention is based on the object of proposing a possibility for providing homogeneous illumination radiation that is improved, in particular more flexible, in relation to the prior art.

The object is achieved by means of an illumination device for a microscope according to main claim 1 and by means of a method according to the alternative independent claim. The dependent claims relate to advantageous developments.

### SUMMARY OF THE INVENTION

The illumination device has at least two providing beam paths, along each of which radiation is guided. Each providing beam path has an optical filter device, by means of which spectral components of the radiation guided in the respective providing beam path are selected or can be selected.

Moreover, per providing beam path there is an input coupling element for the input coupling of the filtered radiation into an interior space of a cavity. The filtered radiation is directed into the interior space via a respective incidence opening. The wall of the interior space is provided with a coating that is reflective for the wavelength of the filtered radiation. The cavity has an exit opening used to emit the radiation that has been homogenized in the cavity owing to multiple reflection as illumination radiation.

Each of the optical filter devices is controllable, in particular individually, and has a plurality of selectable possible filter functions.

The illumination device according to the invention makes it possible both to combine the radiation from a plurality of light sources and to provide illumination radiation having a homogeneous intensity profile. Moreover, by means of the illumination device according to the invention, the wavelengths or wavelength ranges (hereinafter concisely and for simplification: wavelengths) of the radiations directed into the cavity in each case can be individually set and changed or corrected as necessary. In addition, depending on the filter respectively introduced into the relevant providing beam path and/or owing to individual control of the light sources, it is possible to influence the intensity of the illumination radiation.

The respective optical filter devices can be selected from a group comprising filter wheels, filter slides and AOTF (acoustooptical tunable filter). An AOTF, in particular, can also realize a stopping-down effect besides a wavelength-dependent filter function. The filter devices are controlled for example by means of a computer, an FPGA (field programmable gate array) or a microcontroller.

By way of example, laser sources, halogen lamps or LEDs can be used as light sources. One advantage of the illumination device according the invention here is that LEDs of low quality can be used, for example. Owing to the controllable filtering of the radiation coming from the respective light source and also the effect of the diffuse reflections in the interior space of the cavity, a high intensity of the emitted illumination radiation and also a homogeneous intensity profile are attained despite low quality of the light sources.

In possible embodiments of the illumination device according to the invention, one light source is present per providing beam path.

In further embodiments, the radiation provided by one, in particular polychromatic, light source can be split between at least two providing beam paths. The respective radiation portion can be filtered differently in said providing beam paths, such that at the associated incidence openings filtered radiation of different wavelengths is radiated into the interior space of the cavity. In this way, although it is not possible to attain an increase in the intensity of the illumination radiation, it is possible to generate illumination radiation that is coordinated with a sample to be imaged, for example.

In this regard, the sample may be a biological material provided with a plurality of fluorescent markers (fluorophores) of different excitation wavelengths. First illumination radiation coordinated with these fluorescent markers to be excited serves for gentle treatment of the sample. Moreover, the sample can be provided with further fluorescent markers that can be excited by second illumination radiation. If the wavelengths of the first and second illumination radiations are sufficiently far apart and if the fluorescent markers used are sufficiently selective with regard to the respective excitation wavelengths, different fluorescent markers can be excited temporally successively (sequentially) by means of the illumination device according to the invention, for example. The abovementioned solutions from the prior art do not offer such flexibility.

In order to attain a high intensity of the illumination radiation, in one preferred use of the illumination device according to the invention, radiation of the same wavelength from a plurality of light sources is coupled into the cavity. The wavelength to be coupled in specifically in each case can be selected by means of corresponding control of the filter devices.

In order to further modify, in particular filter, the illumination radiation provided by the illumination device, in a further embodiment, a filter can be disposed optically downstream of the exit opening.

As technical elements for the input coupling of the radiation, in particular of the respectively filtered radiation of the respective providing beam paths, in each case arrangements having at least one mirror or having at least two mirrors imaging on one another can be arranged, for example. In further embodiments, deformable mirrors and/or micromirror arrangements (digital micromirror device; DMD) can be used. The input coupling of the filtered radiation via the incidence openings is advantageously effected directly and therefore with low losses.

A further possibility for the input coupling of the radiation consists in coupling the filtered radiation into a light guide, for example into a light-guiding fibre, in accordance with procedures known from the prior art and using likewise previously known technical elements. Such a light guide ends at or in one of the incidence openings, from where the filtered radiation is radiated divergently into the interior space.

The above possible embodiments of the elements for the input coupling of the radiation can also be combined with one another.

In order to reduce unwanted back-reflections in the direction of the incidence openings, in further embodiments of the illumination device, a shutter or a stop can be assigned to each incidence opening in the interior space of the cavity. An additional effect of a shutter or of a stop can furthermore consist in limiting an emission angle range of the radiation propagating divergently starting from the incidence opening and avoiding a direct beam path between incidence opening and exit opening. In this way, no radiation directed into the cavity through the relevant incidence opening passes directly to the exit opening, rather said radiation has to be reflected at least once at the wall of the interior space.

Direct passage of portions of the radiation that has reached the interior space through the exit opening can also be countered by incidence openings being arranged around the exit opening. In this case, the direction of the entering radiation points past the exit opening and even marginal rays of the divergently propagating radiation cannot pass directly to the exit opening.

The cavity can be embodied in particular as an Ulbricht sphere. The reflective inner side of the wall can be coated with polytetrafluoroethylene (PTFE) in order to promote diffuse reflection of the radiation in the interior space. This coating is suitable for wavelengths in a range of approximately 200 to 2000 nm. The sum of the areas of all openings present in the wall, i.e. incidence openings and exit opening, is intended to be less than five percent of the total area of the wall in the interior space.

The illumination device according to the invention can be used in a microscopy method for generating a composite image of a sample. In this case, as a first step, the method comprises providing an illumination device described above. In a second step, a sample is illuminated with illumination radiation that has been homogenized by means of the illumination device. Depending on the selection of the spectral characteristic and the intensity of the illumination radiation, the illumination radiation causes the emission of detection radiation in the sample (step 3). In a fourth step, the detection radiation of a region of the sample is captured in the form of spatially resolved image values of an image. A spatially resolving detector, for example a CCD, CMOS or sCMOS camera, is advantageously used for this purpose. Capture can be effected in the wide field or by means of systematic scanning of the sample region to be imaged, for example by means of a point or line scanner. However, scanning requires an increased technical outlay and requires more time for capturing an image. A captured image is stored with the associated location information of at least some of its pixels.

Steps two to four are repeated at least once, with capture of detection radiation from a further region of the sample as spatially resolved image values of a further image, said further region at least proportionally overlapping a previously captured region. The image information contained in the overlapping image regions can be used to combine a number of individual images to form an overall image (so-called “stitching”).

A sixth step involves computationally combining at least two at least proportionally overlapping images by identifying mutually corresponding image regions of the images and generating a composite image on the basis of the mutually corresponding image regions.

In a further configuration of the method according to the invention, steps two to four can also be repeated using a different wavelength of the illumination radiation. This can be implemented particularly simply with the use of the illumination device according to the invention since the filter devices can be controlled directly and rapidly and a rapid change to a different wavelength of the illumination radiation is thus made possible.

### BRIEF DESCRIPTION OF THE DRAWINGS

The invention will be explained in greater detail below on the basis of exemplary embodiments and with reference to drawings, in which:

FIG. 1 is a schematic illustration of a first exemplary embodiment of an illumination device according to the invention in a median longitudinal section;

FIG. 2 is a schematic illustration of a second exemplary embodiment of an illumination device according to the invention in a median longitudinal section;

FIG. 3 is a schematic and simplified illustration of a microscope having an illumination device according to the invention; and

FIG. 4 illustrates a method sequence of one configuration of the method according to the invention.

### DESCRIPTION OF THE INVENTION

In the exemplary embodiments below, identical technical elements are provided with the same reference signs.

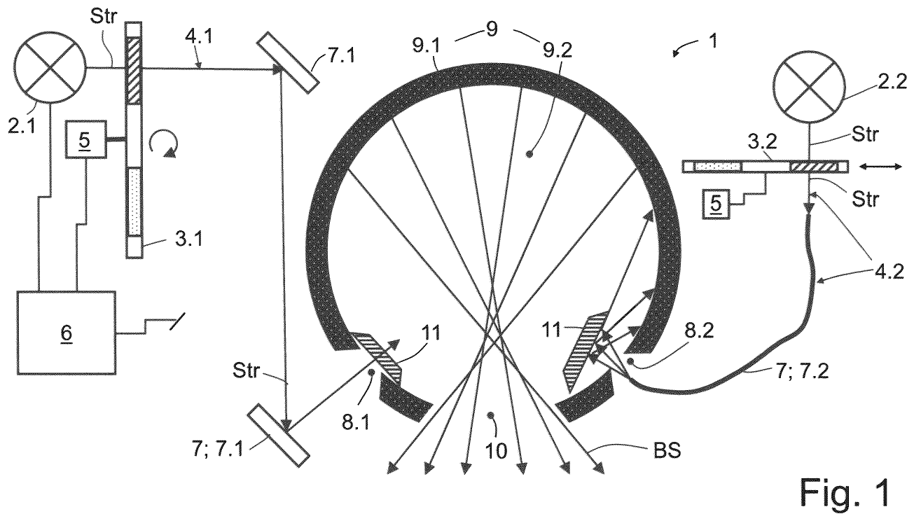

Essential technical elements of an illumination device 1 according to the invention are a first light source 2.1 and a second light source 2.2, a controllable first filter device 3.1 in a first providing beam path 4.1 and a likewise controllable second filter device 3.2 in a second providing beam path 4.2. For combining the radiation Str emitted by each of the light sources 2.1, 2.2, a cavity 9 in the form of an Ulbricht sphere is present (FIG. 1).

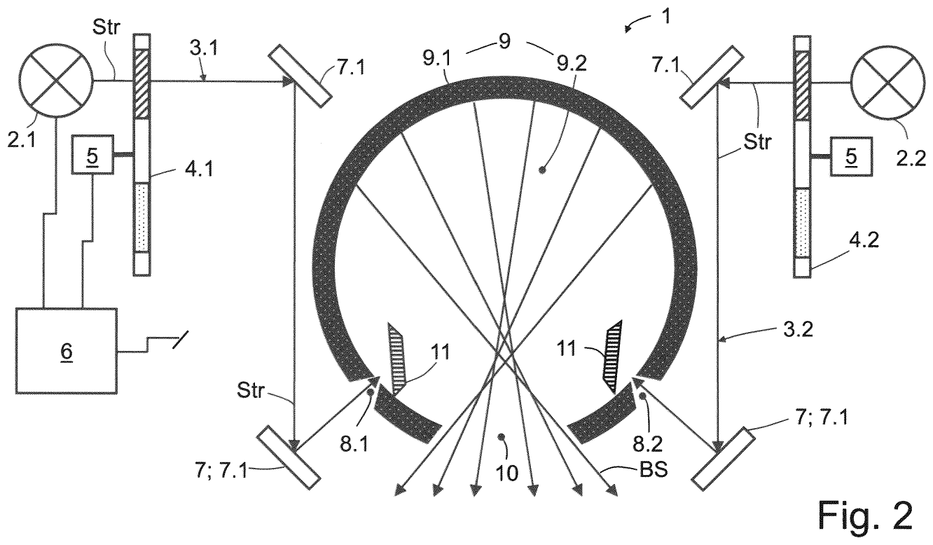

FIG. 1 illustrates two possibilities for the input coupling of the radiation Str into the cavity 9. A first possibility consists in direct input coupling, as is shown on the basis of the example of the first providing beam path 4.1. A further possibility is afforded by indirect input coupling using a light guide 7 in the form of a light-guiding fibre 7.2, illustrated on the basis of the example of the second providing beam path 4.2. In further possibilities for the embodiment of the illumination device 1 according to the invention, all the providing beam paths 4.n (n=1, 2, . . . , n) present can be coupled in directly (see FIG. 2, for example) or indirectly.

By means of the first light source 2.1, radiation Str in a wavelength range in the form of a beam of rays can be emitted and guided along the first providing beam path 4.1. The first filter device 3.1 is embodied as a filter wheel having a number of different filters (symbolized by hatched areas). A current position of the first filter device 3.1 is set by means of control commands of a controller 6. In this case, the controller 6 generates control commands that are converted into an actuating movement of the filter device 3.1 by a drive 5.

The radiation Str passes through the filter respectively placed in the first providing beam path 4.1 and is guided as filtered radiation Str further along the first providing beam path 4.1. A mirror 7.1 has the effect of directing the radiation Str onto a further mirror 7.1 serving as a coupling element 7 for the input coupling of the radiation Str into a first entrance opening 8.1 of the cavity 9. A shutter 11 or a stop 11 is disposed downstream of the first entrance opening 8.1 and reduces a back-reflection of radiation Str from the interior of the cavity 9. The shutter 11 or the stop 11 can optionally be controlled by the controller 6. By way of example, opening and closing of the shutter 11 or the aperture width of the stop 11 can be set. Moreover, temporal control of shutter 11 or stop 11 is optionally possible.

The cavity 9 has an interior space 9.2 bounded by a wall 9.1. That surface of the wall 9.1 which faces the interior 9.2 is provided with a coating, the effect of which is to diffusely reflect the radiation Str directed into the interior space 9.2 (shown in a simplified manner). The radiation Str, or its individual rays, pass to an exit opening 10 in the wall 9.1 of the cavity 9 after at least one reflection, but usually after a plurality of reflections, at different angles. Owing to the reflections and the different emission angles that occur in the process, illumination radiation BS having a homogeneous intensity profile over its beam cross-section and comprising the radiations Str from the first and second light sources 2.1, 2.2 is provided at the exit opening 10.

In the second providing beam path 4.2, the second filter device 3.2 is embodied in the form of a slide, which likewise carries a number of filters and which can be moved transversely with respect to the second providing beam path 4.2 in a manner controlled by means of the associated drive 5.

The radiation Str emitted by the second light source 2.2 is filtered according to the position of the second filter device 3.2 and is coupled into a light guide 7.2 in the form of a light-guiding fibre. In further embodiment possibilities, the light guide 7.2 can also be a light-guiding rod or the like.

The radiation Str directed into the interior space 9.2 from the light guide 7.2 through a second entrance opening 8.2 impinges at an acute angle on a reflective web 11 optionally present and shown by way of example, said web also being referred to as a baffle 11. The radiation Str is reflected back at the wall 9.1 and from there is reflected multiple times until it is emitted together with the radiation Str from the first light source 2.1 through the exit opening 10. A direct beam path from the incidence opening 8.1, 8.2 to the exit opening 10 is blocked by the positioning, extent and optical properties of the web 11 (baffle 11).

In further embodiments of the illumination device 1, more than two providing beam paths 4.n (n=1, 2, . . . , n) and more than two light sources 2.n (n=1, 2, . . . , n) can be present.

In all the exemplary embodiments, the controller 6, in a manner suitable for the transfer of data, is connected to the light sources 2.1, 2.2, the drives 5 and optionally to the shutter 11 or stop 11 in order to control them by means of control commands.

The second exemplary embodiment of the illumination device 1 according to the invention as shown in FIG. 2 has, in both providing beam paths 4.1, 4.2, mirrors 7.1 for the deflection and for the input coupling of the radiation Str into the first and into the second entrance opening 8.1, 8.2, respectively. These are kept very small in terms of their dimensions and therefore already considerably reduce back-reflection of radiation Str into the entrance openings 8.1, 8.2.

In the second exemplary embodiment, a baffle 11 is assigned to each entrance opening 8.1, 8.2 so as to limit an emission angle range of the radiation Str propagating divergently starting from the incidence opening 8.1, 8.2 and to avoid a direct beam path between incidence opening 8.1, 8.2 and exit opening 10. In other words, no radiation Str directed into the cavity through the relevant incidence opening 8.1, 8.2 can pass directly to the exit opening 10.

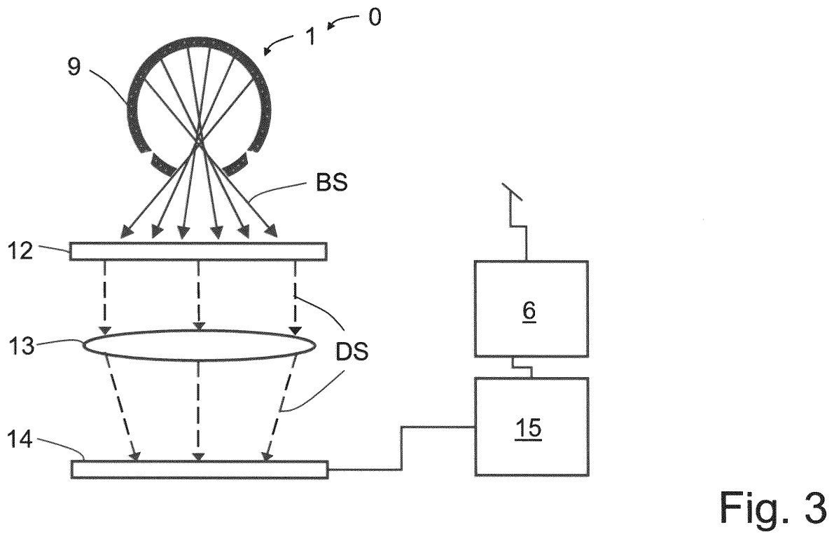

The illumination device 1 is preferably used in a microscope 0. FIG. 3 shows a microscope 0 in a greatly simplified manner, the illustration of the illumination device 1 being limited to the cavity 9 for the sake of better clarity.

The radiation Str that has been homogenized in the cavity 9 as explained emerges from the cavity 9 as illumination radiation BS and impinges on a sample 12. The latter is provided with markers, for example, which are excitable to emit fluorescent radiation as detection radiation DS as a result of the effect of the illumination radiation BS.

In further embodiments, the sample 12 can also be illuminated with the illumination radiation BS without the excitation of fluorescent radiation. Detection radiation DS would then be brought about for example by reflected portions of the illumination radiation BS and/or by portions of the illumination radiation BS which pass through the sample 12.

The detection radiation DS brought about can be captured by means of a reflected light arrangement or by way of transmitted light (see FIG. 3) with the aid of an objective 13 and can be directed onto a spatially resolved detector 14. The image values captured in a spatially resolved manner by means of the detector 14 are communicated to an evaluation device for example a computer or a CPU, are evaluated and are repeatedly retrievably stored in a memory comprised by the evaluation device 15.

The evaluation device 15 can be configured such that it checks the captured image values in regard to compliance with predefined parameters. If predetermined parameters are not complied with and a desired imaging quality is therefore not attained, corresponding information can be passed to the controller 6 in order, by means of control commands generated there, as necessary, to change current settings of the light sources 2.1, 2.2 and/or of the filter devices 3.1, 3.2 in the sense of feedback control.

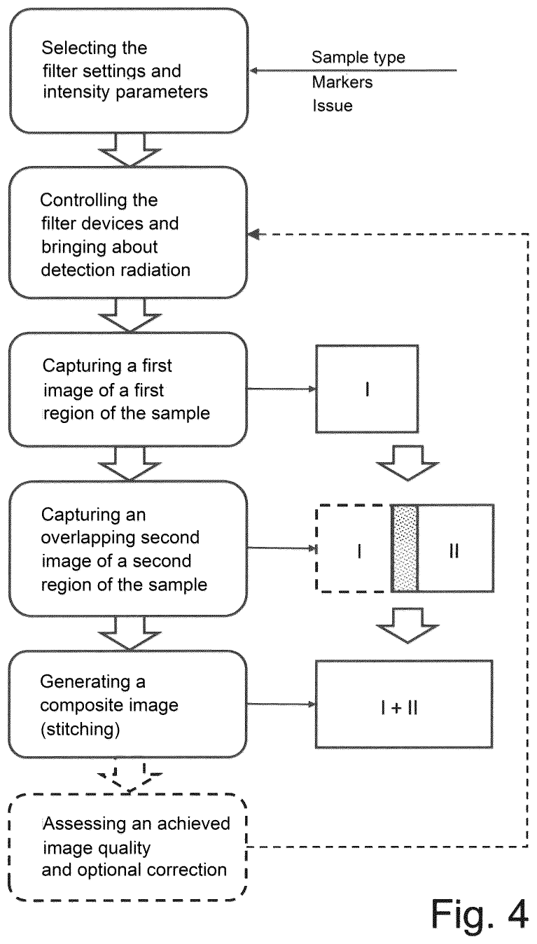

The sequence of one method configuration using an illumination device 1 is shown by way of example in FIG. 4.

The settings to be used for the filter devices 3.1, 3.2 and also the parameters of the light sources 2.1, 2.2 are selected on the basis of information concerning specifics of the examination to be performed, for example concerning the type of sample to be imaged, the markers optionally used, and the issue to be examined. The filter devices 3.1, 3.2 and/or the light sources 2.1, 2.2 are controlled accordingly, and illumination radiation BS as explained above is generated and directed onto the sample 12. The detection radiation DS of a region of the sample 12 that is brought about as a result is captured in the form of spatially resolved image values of a first image I. In a further step, detection radiation DS of a further region of the sample 12 is brought about and likewise captured as spatially resolved image values of a further image II. In this case, the captured regions, and thus the captured images I and II, overlap at least proportionally (represented by a dotted area).

The image values shared by the two images I and II in the overlapping region are used to computationally combine the images I and II to form a composite image I+II. Further composite images I+II+N can be generated by way of further image capture procedures in the sense described.

As already mentioned with regard to FIG. 3, the captured image values can additionally be used for checking the image quality. By way of example, it may be ascertained that as the image capture duration increases, the intensities of the image values decrease because markers used undergo bleaching, for example.

In an optional step (interrupted full line), the settings of the light sources 2.1, 2.2 and/or of the filter devices 3.1, 3.2 can be updated in the sense of feedback control.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE SIGNS

0 Microscope
1 Illumination device
2.1 First light source
2.2 Second light source
3.1 First providing beam path
3.2 Second providing beam path
4.1 First filter device
4.2 Second filter device
5 Drive
6 Controller
7 Coupling element
7.1 Mirror
7.2 Light guide
8.1 First incidence opening
8.2 Second incidence opening
9 Cavity, Ulbricht sphere
9.1 Wall
9.2 Interior space
10 Exit opening
11 Shutter, stop, baffle
12 Sample
13 Objective
14 Detector
15 Evaluation device
BS Illumination radiation
DS Detection radiation
I First image
II Second image
Str (filtered) radiation

1. Illumination device for a microscope, comprising
at least two providing beam paths, along each of which radiation is guided, each providing beam path having an optical filter device, by means of which spectral components of the radiation guided in the respective providing beam path are selected;
per providing beam path an input coupling element for the input coupling of the filtered radiation via a respective incidence opening into an interior space of a cavity provided with a coating that is reflective for the filtered radiation, in particular into an Ulbricht sphere, the cavity having an exit opening used to emit the radiation that has been homogenized in the cavity owing to multiple reflection as illumination radiation (BS);
wherein each of the optical filter devices is individually controllable and has a plurality of selectable possible filter functions.

2. Illumination device according to claim 1, wherein the respective optical filter devices are selected from a group comprising filter wheels, filter slides and AOTF.

3. Illumination device according to claim 1, wherein a filter is disposed downstream of the exit opening.

4. Illumination device according to claim 1, wherein incidence openings are arranged around the exit opening (10).

5. Illumination device according to claim 1, wherein a shutter or a stop is assigned to each incidence opening in the interior space of the cavity.

6. Illumination device according to claim 1, wherein a web is assigned to at least one incidence opening in the interior space of the cavity, the effect of which web is to limit an emission angle range of the radiation propagating divergently starting from the incidence opening and to avoid a direct beam path between incidence opening and exit opening.

7. Microscopy method for generating a composite image of a sample, comprising the following steps:
i) providing an illumination device according to claim 1;
ii) illuminating the sample with illumination radiation that has been homogenized by means of the illumination device;
iii) causing the emission of detection radiation in the illuminated sample;
iv) capturing the detection radiation of a region of the sample as spatially resolved image values of an image;
v) repeating steps ii) to iv) at least once, with capture of detection radiation from a further region of the sample as spatially resolved image values of a further image, said further region at least proportionally overlapping a previously captured region;
vi) combining at least two at least proportionally overlapping images by identifying mutually corresponding image regions of the images and generating a composite image on the basis of the mutually corresponding image regions.
